(19) United States
(12) Patent Application Publication
(10) Pub. No.: US 2017/0185354 A1
(43) Pub. Date: Jun. 29, 2017

(54) Techniques for a Write Transaction at a Storage Device

(71) Applicant: Intel Corporation, Santa Clara, CA (US)

(72) Inventors: KSHITIJ A. DOSHI, CHANDLER, AZ (US); SANJEEV N. TRIKA, PORTLAND, OR (US); SRIDHARAN SAKTHIVELU, DUPONT, WA (US)

(73) Assignee: Intel Corporation, Santa Clara, CA (US)

(21) Appl. No.: 14/757,603

(22) Filed: Dec. 23, 2015

(51) Int. Cl. G06F 3/06; G06F 12/10

(52) U.S. Cl. CPC G06F 3/0688; G06F 3/0685; G06F 3/0659; G06F 3/0619; G06F 12/1027; G06F 3/065

(57) ABSTRACT

Examples include techniques for a write transaction to one or more memory devices maintained at a storage device. In some examples, the write transaction includes a disjointed atomic write transaction that includes a plurality of asynchronous write operations from an application or operating system executing on a computing platform to a storage device coupled with the computing platform. For these examples, the disjointed atomic write transaction is associated with a multi-block transaction request initiated by the application or operating system that upon acceptance results in the plurality of asynchronous write operations to the storage device.

### TECHNICAL FIELD

Examples described herein are generally related to techniques for write transactions or write operations to a storage device.

### BACKGROUND

In some examples, file-systems, databases or object-systems may be associated with different types of applications or an operating system (OS). For these examples, an application or OS may issue a transaction such as a set of write operations to a non-volatile memory (e.g., a write transaction) included in a storage device. The application or OS typically needs to ensure that the write transaction completes before issuing a next transaction. A need to ensure a write transaction completes may characterize write operations associated with these types of write transactions as atomic write transactions.

### BRIEF DESCRIPTION OF THE DRAWINGS

FIG. 1 illustrates an example first system.

FIG. 2 illustrates an example first process.

FIG. 3 illustrates an example second process.

FIG. 4 illustrates an example block diagram for an apparatus.

FIG. 5 illustrates an example of a logic flow.

FIG. 6 illustrates an example of a storage medium.

FIG. 7 illustrates an example storage device.

FIG. 8 illustrates an example computing platform.

### DETAILED DESCRIPTION

As contemplated in the present disclosure, applications or an OS associated with file-systems, databases or object-systems may need to ensure that a write transaction to a storage device completes before issuing a next transaction. The need to ensure the write transaction completes requires a logically atomic write transaction to provide data consistency for users of these applications or the OS. Logically atomic write transactions may allow for multiple operations to be grouped into a single logical entity that may enable these applications or the OS to either see all write transactions completed or none of the write transaction completed. Storage devices such as hard disk drives (HDDs) or solid state drives (SSDs) may not provide an atomicity guarantee. Some storage devices may provide an atomic guarantee to a 512 byte sector, while other storage devices may provide an atomic guarantee to a 4 kilobyte (KB) page. Yet other storage devices may guarantee that a contiguous chunk of 64 KB may be written atomically. None of these techniques allow for a disjointed atomic write transaction.

In some examples, applications or an OS associated with file systems, databases, etc. may synthesize their respective needed atomicity guarantees for indivisibly writing arbitrary sized and arbitrarily scattered data on an HDD or SSD by using several classical techniques like copy-and-update, journaling, ordered updates, two pass writes, sequenced additional metadata writes, etc. These techniques generally double a number of write operations to a storage device and thus may significantly hurt both performance and endurance of the storage device. It is with respect to the above-mentioned and other challenges that the examples described herein are needed.

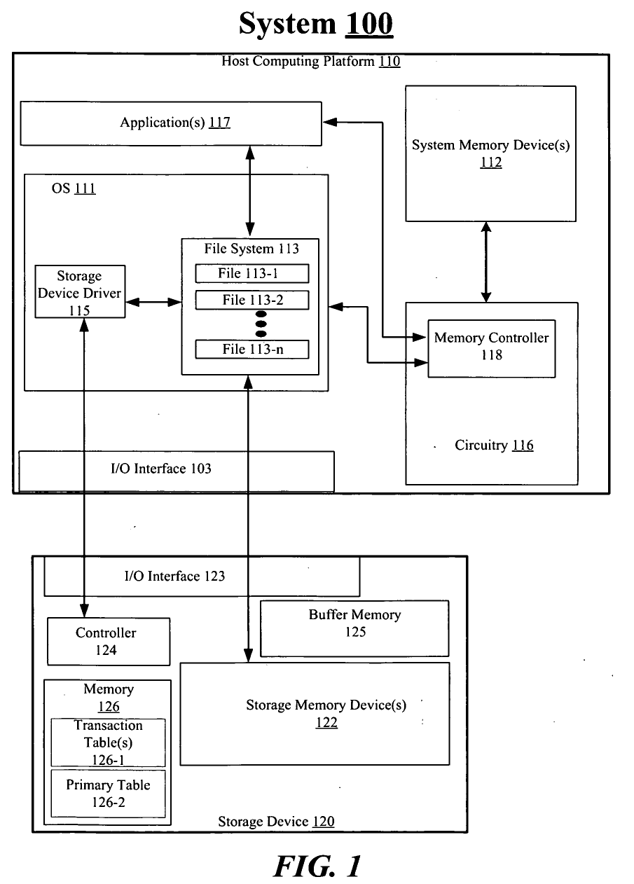

FIG. 1 illustrates an example system 100. In some examples, as shown in FIG. 1, system 100 includes a host computing platform 110 coupled to a storage device 120 through input/output (I/O) interface 103 and I/O interface 123. Also, as shown in FIG. 1, host computing platform 110 may include an OS 111, one or more system memory device(s) 112, circuitry 116 and one or more application(s) 117. For these examples, circuitry 116 may be capable of executing various functional elements of host computing platform 110 such as OS 111 and application(s) 117 that may be maintained, at least in part, within system memory device(s) 112. Circuitry 116 may include host processing circuitry to include one or more central processing units (CPUs) and associated chipsets and/or controllers.

According to some examples, as shown in FIG. 1, OS 111 may include a file system 113 and a storage device driver 115 and storage device 120 may include a controller 124, one or more storage memory device(s) 122 and memory 126. OS 111 may be arranged to implement storage device driver 115 to coordinate at least temporary storage of data for a file from among files 113-1 to 113-n, where “n” is any whole positive integer >1, to storage memory device(s) 122. The data, for example, may have originated from or may be associated with executing at least portions of application(s) 117 and/or OS 111. As described in more detail below, the OS 111 communicates one or more commands and transactions with storage device 120 to write data to storage device 120. The commands and transactions may be organized and processed by logic and/or features at the storage device 120 to implement a disjointed atomic write transaction to write the data to storage device 120.

In some examples, controller 124 may include logic and/or features to receive a multi-block write transaction request for a disjointed atomic write transaction to storage memory device(s) 122 at storage device 120. For these examples, the disjointed atomic write transaction may be initiated by or sourced from an application such as application(s) 117 that utilizes file system 113 to write data to storage device 120 through input/output (I/O) interfaces 103 and 123. According to some examples, logic and/or features of controller 124 may assign a transaction identification (e.g., a token) to the multi-block write transaction request and send the transaction identification to the source of the request. The source (e.g., application(s) 117) may then send a plurality of asynchronous write operations to store data to storage memory device(s) 122. Each of the plurality of asynchronous write operations may include the transaction identification. Although examples, are not limited to a need for a transaction identification for a given disjointed atomic write transaction. In some examples, a single command may be issued without the need for the transaction identification.

According to some first examples, as described more below, logic and/or features of controller 124 may first store data for each asynchronous write operation in buffer memory 125. For these first examples, an indication of a completion of the disjointed atomic write transaction may be received by controller 124 from the source of the multi-block write transaction request. Responsive to this indication, logic and/or features of controller 124 may cause the data stored in buffer memory 125 to be stored or committed for storage to storage memory device(s) 122.

In an alternative of the above mentioned first examples, an indication of canceling or ending the disjointed atomic write transaction may be received before a completion indication is received. For this alternative, data stored in buffer memory 125 for asynchronous write operations received up to the indication of canceling or ending the disjointed atomic write transaction may be discarded or may be merely written over. In either example of discarding or writing over, the data is not caused to be committed for storage to storage memory device(s) 122 responsive to the canceling or ending indication.

In some examples, buffer memory 125 may include volatile types of memory including, but not limited to, random-access memory (RAM), Dynamic RAM (D-RAM), double data rate synchronous dynamic RAM (DDR SDRAM), static random-access memory (SRAM), Thyristor RAM (T-RAM) or zero-capacitor RAM (Z-RAM). However, examples are not limited in this manner, and in some instances, buffer memory 125 may include non-volatile types of memory, including, but not limited to, 3-dimensional cross-point memory, ferroelectric memory, silicon-oxide-nitride-oxide-silicon (SONOS) memory, polymer memory, ferroelectric polymer memory, ferroelectric transistor random access memory (FeTRAM or FeRAM), ovonic memory, nanowire, electrically erasable programmable read-only memory (EEPROM), phase change memory, memristors or spin transfer torque-magnetoresistive random access memory (STT-MRAM).

According to some second examples, as described more below, logic and/or features of controller 124 may store data for each asynchronous write operation directly to storage memory device(s) 122. For these second examples, following the storing of the data at physical memory addresses for storage memory device(s) 122, a transaction-specific logical-to-physical (L2P) indirection table may be created by logic and/or features of controller 124 for mapping the data for each of the asynchronous write operations to respective physical memory addresses. The transaction-specific L2P indirection table, for example, may be stored in memory 126 with transaction table(s) 126-1. For these second examples, an indication of a completion of the disjointed atomic write transaction may be received by controller 124 from the source of the multi-block write transaction request. Responsive to this indication, logic and/or features of controller 124 may cause a primary L2P indirection table to be updated. The primary L2P indirection table may be stored in memory 126 and is represented in FIG. 1 as primary table 126-2. Primary table 126-2 may map data written to storage memory device(s) 122 for write operations received to physical memory addresses.

In an alternative of the above mentioned second examples, an indication of canceling or ending the disjointed atomic write transaction may be received before a completion indication is received. For this alternative, the transaction-specific L2P indirection table included in transaction table(s) 126-1 may then be discarded, deleted or the logic and/or features may write over the transaction-specific L2P indirection table when a subsequent transaction-specific L2P indirection table is created. In either example of discarding or writing over, the transaction-specific L2P indirection table is not used to update the primary L2P indirection table responsive to the canceling or ending indication.

In some examples, memory 126 that may be arranged to store transaction table(s) 126-1 or primary table 126-2 may include volatile types of memory including, but not limited to, RAM, D-RAM, DDR SDRAM, SRAM, T-RAM or Z-RAM. One example of volatile memory includes DRAM, or some variant such as SDRAM. A memory subsystem as described herein may be compatible with a number of memory technologies, such as DDR4 (DDR version 4, initial specification published in September 2012 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (LPDDR version 5, currently in discussion by JEDEC), HBM2 (HBM version 2, currently in discussion by JEDEC), and/or others, and technologies based on derivatives or extensions of such specifications.

However, examples are not limited in this manner, and in some instances, memory 126 may include non-volatile types of memory, whose state is determinate even if power is interrupted to memory 126. In some examples, memory 126 may include non-volatile types of memory that is a block addressable, such as for NAND or NOR technologies. Thus, a memory 126 can also include a future generation of types of non-volatile memory, such as a 3-dimensional cross-point memory, or other byte addressable non-volatile types of memory. According to some examples, the memory 126 may include types of non-volatile memory that includes chalcogenide glass, multi-threshold level NAND flash memory, NOR flash memory, single or multi-level Phase Change Memory (PCM), a resistive memory, nanowire memory, FeTRAM, MRAM that incorporates memristor technology, or STT-MRAM, or a combination of any of the above, or other memory.

In some examples, storage memory device(s) 122 may be a device to store data from write transactions and/or write operations. Storage memory device(s) 122 may include one or more chips or dies having gates that may individually include one or more types of non-volatile memory to include, but not limited to, NAND flash memory, NOR flash memory, 3-D cross-point memory, ferroelectric memory, SONOS memory, ferroelectric polymer memory, FeTRAM, FeRAM, ovonic memory, nanowire, EEPROM, phase change memory, memristors or STT-MRAM. For these examples, storage device 120 may be arranged or configured as a solid-state drive (SSD). The data may be read and written in blocks and a mapping or location information (e.g., L2P indirection tables) for the blocks may be kept in transaction table(s) 126-1 and/or primary table 126-2.

Examples are not limited to storage devices arranged or configured as SSDs, other storage devices such as a hard disk drive (HDD) are contemplated. In these instances, the storage memory device (s) 122 may include one or more platters or rotating disks having a magnet material to store data. The data may be read and written in blocks and a mapping or location information for the blocks may be kept in transaction table(s) 126-1 and/or primary table 126-2.

According to some examples, communications between storage device driver 115 and controller 124 for data stored in storage memory devices(s) 122 and accessed via files 113-1 to 113-n may be routed through I/O interface 103 and I/O interface 123. I/O interfaces 103 and 123 may be arranged as a Serial Advanced Technology Attachment (SATA) interface to couple elements of host computing platform 110 to storage device 120. In another example, I/O interfaces 103 and 123 may be arranged as a Serial Attached Small Computer System Interface (SCSI) (or simply SAS) interface to couple elements of host computing platform 110 to storage device 120. In another example, I/O interfaces 103 and 123 may be arranged as a Peripheral Component Interconnect Express (PCIe) interface to couple elements of host computing platform 110 to storage device 120. In another example, I/O interfaces 103 and 123 may be arranged as a Non-Volatile Memory Express (NVMe) interface to couple elements of host computing platform 110 to storage device 120. For this other example, communication protocols may be utilized to communicate through I/O interfaces 103 and 123 as described in industry standards or specifications (including progenies or variants) such as the Peripheral Component Interconnect (PCI) Express Base Specification, revision 3.1, published in November 2014 (“PCI Express specification” or “PCIe specification”) and/or the Non-Volatile Memory Express (NVMe) Specification, revision 1.2, also published in November 2014 (“NVMe specification”).

In some examples, system memory device(s) 112 may store information and commands which may be used by circuitry 116 for processing information. Also, as shown in FIG. 1, circuitry 116 may include a memory controller 118. Memory controller 118 may be arranged to control access to data at least temporarily stored at system memory device(s) 112 for eventual storage to storage memory device(s) 122 at storage device 120.

In some examples, storage device driver 115 may include logic and/or features to forward commands associated with one or more write transactions and/or write operations originating from application(s) 117. For example, the storage device driver 115 may forward commands associated with write transactions such that a number of asynchronous write operations for a disjointed atomic write transaction may cause data to be stored to storage memory device(s) 122 at storage device 120. More specifically, storage device driver 115 can enable communication of the write operations from application(s) 117 at computing platform 110 to controller 124. Thus, coordination of write operations for the disjointed atomic write transaction may be handled and processed by logic and/or features of controller 124 to cause an increase of queue-depth, e.g. the number of commands in queue to write data to storage memory device(s) 122 such that command-parallelism may be achieved. In other words, by allowing write operations to storage memory device(s) 122 to progress in parallel using the disjointed atomic write transaction, a queue-depth for write operations to storage memory device(s) 122 may be increased by a factor of 2× or greater. Also, application(s) 117 and/or OS 111 may be able to provide indivisible writes of arbitrary numbers of scattered blocks of memory to storage memory device(s) 122 and, as described more below, may enable application(s) 117 and/or OS 111 to discover incomplete writes across an interruption thus removing a need to maintain explicit journaling/logging.

System Memory device(s) 112 may include one or more chips or dies having volatile types of memory such RAM, D-RAM, DDR SDRAM, SRAM, T-RAM or Z-RAM. However, examples are not limited in this manner, and in some instances, system memory device(s) 112 may include non-volatile types of memory, including, but not limited to, NAND flash memory, NOR flash memory, 3-D cross-point memory, ferroelectric memory, SONOS memory, ferroelectric polymer memory, FeTRAM, FeRAM, ovonic memory, nanowire, EEPROM, phase change memory, memristors or STT-MRAM.

According to some examples, host computing platform 110 may include, but is not limited to, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof.

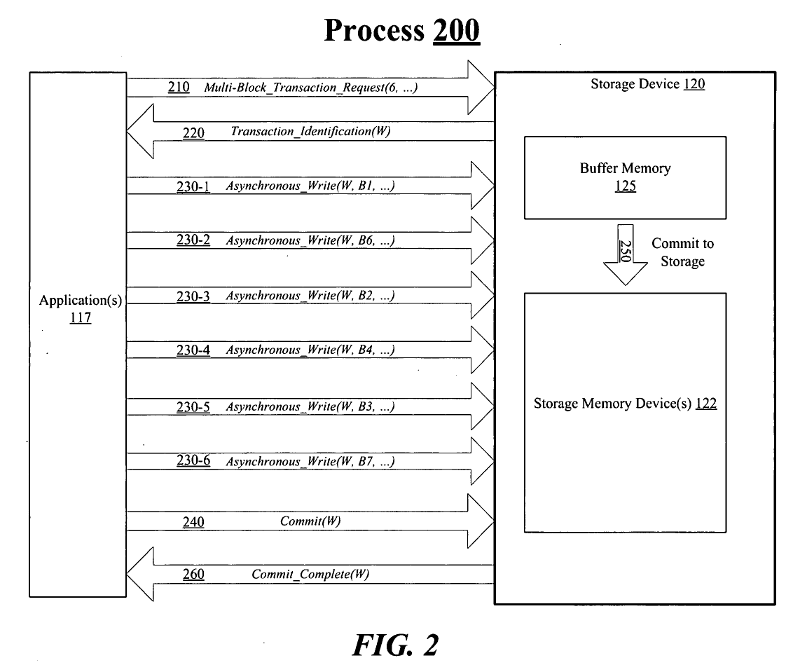

FIG. 2 illustrates an example process 200. In some examples, process 200 as shown in FIG. 2 depicts a process to implement a disjointed atomic write transaction associated with a multi-block write transaction request. For these examples, process 200 may be implemented by or using components or elements of system 100 shown in FIG. 1 such as application(s) 117, storage device 120, controller 124, buffer memory 125, memory 126 or storage memory device(s) 122. However, process 200 is not limited to being implemented by or use only these component or elements of system 100.

In some examples, at 210, a multi-block transaction request may be sent or submitted by application(s) 117 for a disjointed atomic write transaction. The disjointed atomic write transaction may include allowing application(s) 117 to perform multiple asynchronous write operations, in any arbitrary order convenient for application(s) 117, while also limiting the total number of blocks to be written to in storage memory device(s) 122. As shown in FIG. 2, Multi-Block_Transaction_Request(6, . . . ) is sent from Applications(s) 117 to storage device 120. The value of “6” in Multi-BlockTransactionRequest(6, . . . ) indicates a total number of six blocks of memory in storage memory device(s) 122 that are to be written for the disjointed atomic write transaction. Examples are not limited to six blocks, any number of blocks may be indicated in a multi-block transaction request.

According to some examples, at 220, a Transaction_Identification(W) may be sent to application(s) 117. For these examples, logic and/or features of controller 124 may generate a transaction identification (W) that may serve as a token to facilitate tracking of subsequent write operations through completion or early termination and may also serve as an indication that the Multi-Block_Transaction_Request(6, . . . ) has been granted.

In some examples, at 230-1 to 230-6, a series of six asynchronous write operations may be received at storage device 120. For example, at 230-1, Asynchronous_Write(W, B1, . . . ) may represent a first asynchronous write operation from application(s) 117 that seeks to write to block 1 (B1) as part of the six block disjointed atomic write transaction that was assigned transaction identification or token (W). Each asynchronous write block “B₁”, where “i” is any whole, positive integer, may be a single logical block address (LBA) or a range of LBAs, subject to a total capacity of six blocks that application(s) 117 reserved/requested via Multi-Block_Transaction_Request(6, . . . ). As shown in FIG. 2, at 230-2 to 230-6, five more asynchronous write operations to respective blocks B6, B2, B4, B3 and B7 indicate asynchronous or disjointed write operations submitted by application(s) 117. The order of respective block B6, B2, B4 and B7 are arbitrarily ordered and examples are not limited to the order shown in FIG. 2 for process 200. Also, in some examples, blocks B6, B2, B4, B3 and B7 may be written to scattered portions of storage memory device(s) 122.

According to some examples, logic and/or features of controller 124 may cause data for each asynchronous write operation to be first stored to buffer memory 125. Buffer 125 may be a relatively high speed memory buffer (e.g., SRAM) to at least temporarily store the data received with the asynchronous write operations for the disjointed atomic write transaction. In some examples, the data may be stored in buffer memory 125 until an indication of a completion of the disjointed atomic write transaction. The indication, as shown in FIG. 2 at 260, may be a Commit(W) command sent from the application with transaction identifier (W) that indicates application(s) 117 have completed the disjointed atomic write transaction after sending the last of the six asynchronous write operations.

In some examples, logic and/or features of controller 124 may recognize the transaction identification included in Commit(W) command as an indicator of the completion of the disjointed atomic write transaction. For these examples, at 250, the logic and/or features of controller 124 may cause the data received via the six multi-block write operations to be committed to storage in storage memory device(s) 122 and then send a Commit_Complete(W) responsive to the application with the transaction identifier (W) to indicate that the data for the six multi-block write operations sent in the multi-block transaction request has been successfully stored to storage memory device(s) 122.

According to some examples, during submittal of the six asynchronous write operations, application(s) 117 does not have to wait for completion of the entire multi-block write transaction. Rather, application(s) 117 may check for exceptions or indications received from storage device 120, possibly received in an asynchronous manner. Application(s) 117 may then take remedial action that may include discontinuing or ending the disjointed atomic write transaction before the multi-block write transaction is completed. Discontinuing or ending the disjointed atomic write transaction may include application(s) 117 sending a Cancel(W), for example, before sending a Commit(W) may indicate to logic and/or features of controller 124 that application(s) 117 want to cancel or end the disjointed atomic write transaction. Responsive to the Cancel(W) having the transaction identification given at 210, logic and/or features of controller 124 may cause the data currently stored to buffer memory 125 up to the time of receiving the Cancel(W) to be deleted or may cause the data to not be stored or committed for storage to storage memory device(s) 122.

In some examples, buffer memory 125 may include volatile types of memory. For these examples, loss of primary power or a power-fail event to storage device 120 before the data is committed to storage to storage memory device(s) 122 may cause the loss of at least a portion of the data included in completed write operations submitted by application(s) 117. For these examples, logic and/or features of controller 124 may be capable of detecting a power-fail event impacting storage device 120 and then utilize auxiliary power to cause any data not yet stored from memory buffer 125 to storage memory device(s) 122 to be stored. The auxiliary power, for example, may include capacitance-based power provided by power loss imminent circuitry (not shown) and the primary power may include either battery-based or power outlet-based power (not shown). The capacitance-based power may include sufficient capacitance power storage to provide auxiliary power to buffer memory 125 to enable a worst case scenario of needing to transport data for all six blocks of data included in the six asynchronous write operations shown in FIG. 2 from buffer memory 125 to memory device(s) 122 following a power-fail event for storage device 120.

According to some examples, following the storage of data for the disjointed atomic write transaction to storage memory device 122, logic and/or features of controller 124 may update the primary L2P indirection table included in primary tables 126-2 of memory 126 to indicate the L2P mapping of data included in the multi-block write operations received from application(s) 117.

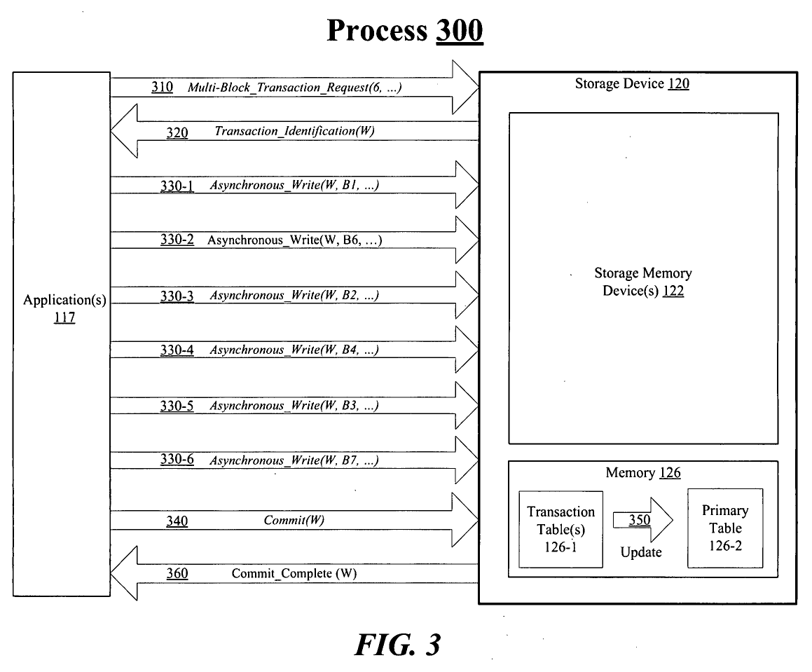

FIG. 3 illustrates an example process 300. In some examples, process 300 as shown in FIG. 3 depicts a process to implement a disjointed atomic write transaction associated with a multi-block write transaction request. For these examples, process 300 may be implemented by or use components or elements of system 100 shown in FIG. 1 such as application(s) 117, storage device 120, controller 124, memory 126 or storage memory device(s) 122. However, process 300 is not limited to being implemented by or use only these component or elements of system 100.

In some examples, at 310, a multi-block transaction request may be sent or submitted by application(s) 117 for a disjointed atomic write transaction. Similar to process 200, at 320, logic and/or features of controller 124 may generate a transaction identification to serve as a token to facilitate tracking of subsequent write operations through completion or early termination and also serve as an indication that Multi-Block_Transaction_Request(6, . . . ) has been granted.

According to some examples, similar to process 200, at 330-1 to 330-6, a series of six asynchronous write operations may be received at storage device 120. However, process 300 is different than process 200 in that a memory buffer is not used to temporarily store data before committing to storage to storage memory device(s) 122. Rather, logic and/or features of controller 124 may cause data for each asynchronous write operation to be stored in physical memory addresses of storage memory device(s) 122 when received from application(s) 117. Following the storage of the data to storage memory device(s) 122, logic and/or features of controller 124 may create a transaction-specific L2P indirection table for mapping the data included in the multiple asynchronous write operations to the physical memory addresses of storage memory device(s) 122. For these examples, the transaction-specific L2P indirection table may be associated with the transaction identification (W) or token assigned to the granted multi-block transaction request and may be included or stored with transaction table(s) 126-1 maintained in memory 126.

In some examples, logic and/or features of controller 124 may continue to maintain the transaction-specific L2P indirection table until at least receiving Commit(W) at 340. Responsive to receiving Commit(W) command from application(s) 117, logic and/or features of controller 124 at 350 may use the transaction-specific L2P indirection table to update a primary L2P indirection table included in primary table 126-2 maintained in memory 126. Following this update, logic and/or features of controller 124 may then send a Commit_Complete(W) response to indicate that the data for the six multi-block write operations has been successfully stored to storage memory device(s) 122.

According to some examples, during submittal of the six asynchronous write operations, application(s) 117 does not have to wait for completion of all the write operations. Rather, application(s) 117 may check for exceptions or indications received from storage device 120, that may be received in an asynchronous manner. Application(s) 117 may then take remedial action that may include discontinuing or ending the disjointed atomic write transaction before the multi-block write operations are completed. Discontinuing or ending the disjointed atomic write transaction may include application(s) 117 sending a Cancel(W), for example, before sending a Commit(W) may indicate to logic and/or features of controller 124 that application(s) 117 want to cancel or end the disjointed atomic write transaction. Responsive to the Cancel(W) having the transaction identification given at 310, logic and/or features of controller 124 may cause the transaction-specific L2P indirection table included in transaction table(s) 126-1 to be deleted or may cause the primary L2P indirection table to not be updated with the transaction-specific L2P indirection table.

In some examples, at least a portion of memory 126 arranged to maintain transaction table(s) 126-1 may include volatile types of memory. For these examples, loss of power or a power-fail event to storage device 120 before the primary L2P indirection table is updated may cause the data included in the write operations submitted by application(s) 117 to be inaccessible. For these examples, logic and/or features of controller 124 may be capable of detecting a power-fail event impacting storage device 120 and then utilize auxiliary power to cause the primary L2P indirection table to be updated based on the transaction-specific L2P indirection table. The auxiliary power, for example, may include capacitance power (not shown). This capacitance power may include sufficient capacitance power storage provided to enable the update process to be completed following a power-fail event for storage device 120.

According to some examples, portions of memory 126 maintaining transaction table(s) 126-1 and primary table 126-2 may include volatile types of memory. For these examples, the update process may not be possible using auxiliary power before the primary L2P indirection table has to be saved to a non-volatile memory following a power-fail event. In some examples, rather than using the transaction-specific L2P indirection table to update the primary L2P indirection table, the transaction-specific L2P indirection table may also be stored to a non-volatile memory using auxiliary power. For these examples, once power is restored to storage device 120, the transaction-specific L2P indirection table may then be written or loaded back to volatile memory portions of memory 126 and used to update the primary L2P indirection table.

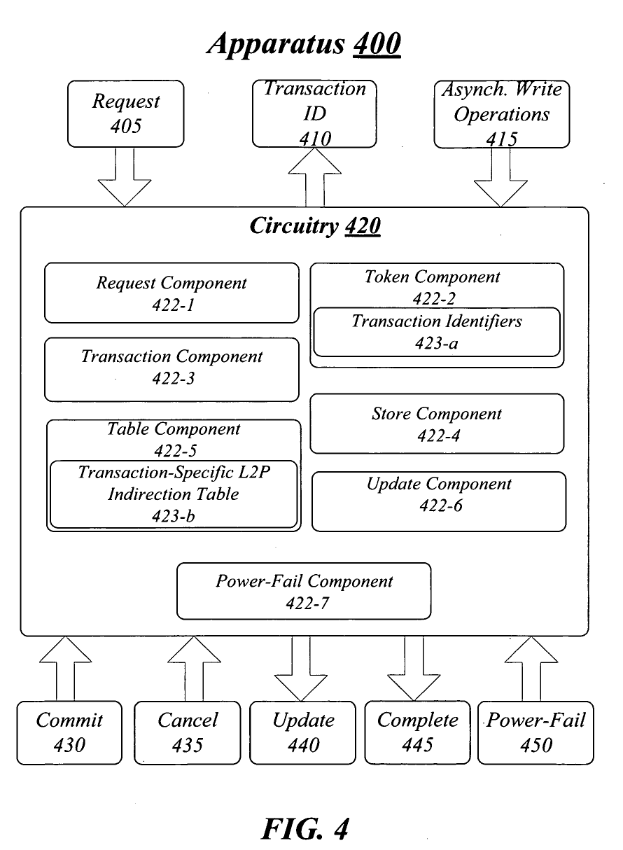

FIG. 4 illustrates an example block diagram for an apparatus 400. Although apparatus 400 shown in FIG. 4 has a limited number of elements in a certain topology, it may be appreciated that the apparatus 400 may include more or less elements in alternate topologies as desired for a given implementation.

The apparatus 400 may be supported by circuitry 420 and apparatus 400 may be a controller maintained at a storage device such as controller 124 for storage device 120 of system 100 shown in FIG. 1. The storage device may be coupled to a host computing platform or device similar to host computing platform 110 also shown in FIG. 1. Also, as mentioned above, the storage device may include one or more memory devices or dies to store data associated with a disjointed atomic write transaction associated with a multi-block write transaction request placed by one or more applications hosted by the host computing platform. Circuitry 420 may be arranged to execute one or more software or firmware implemented components or modules 422-a (e.g., implemented, at least in part, by a storage controller of a storage device). It is worthy to note that “a” and “b” and “c” and similar designators as used herein are intended to be variables representing any positive integer. Thus, for example, if an implementation sets a value for a=7, then a complete set of software or firmware for components or modules 422-a may include components 422-1, 422-2, 422-3, 422-4, 422-5, 422-6 or 422-7. Also, these “components” may be software/firmware stored in computer-readable media, and although the components are shown in FIG. 4 as discrete boxes, this does not limit these components to storage in distinct computer-readable media components (e.g., a separate memory, etc.).

According to some examples, circuitry 420 may include a processor or processor circuitry. The processor or processor circuitry can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Atom®, Celeron®, Core (2) Duo®, Core i3, Core i5, Core i7, Itanium®, Pentium®, Xeon®, Xeon Phi® and XScale® processors; and similar processors. According to some examples circuitry 420 may also include one or more application-specific integrated circuits (ASICs) and at least some components 422-a may be implemented as hardware elements of these ASICs.

According to some examples, apparatus 400 may include a request component 422-1. Request component 422-1 may be a logic and/or feature executed by circuitry 420 to receive a multi-block write transaction request for a disjointed atomic write transaction to one or more storage memory devices. For these examples, the multi-block write transaction request may be included in request 405 and the one or more storage memory devices may be located at the storage device that includes apparatus 400. Request 405, for example, may have been sent from an application executing at a host computing device coupled with the storage device that includes apparatus 400.

In some examples, apparatus 400 may also include a token component 422-2. Token component 422-2 may be a logic and/or feature executed by circuitry 420 to send an indication of acceptance of the multi-block write transaction request to a source of the multi-block write transaction request. The indication of acceptance may include a transaction identification for the multi-block write transaction request. The transaction identification, for example, may be sent to the application executing at the host computing platform and may be included in transaction ID 410. Also, token component 422-2 may maintain the transaction identification with transaction identifiers 423-a (e.g., in a lookup table (LUT)).

According to some examples, apparatus 400 may also include a transaction component 422-3. Transaction component 422-3 may be a logic and/or feature executed by circuitry 420 to receive a plurality of asynchronous write operations to store data to the one or more storage memory devices, the plurality of asynchronous write operations may separately include the transaction identification. For these examples, the plurality of received asynchronous write operations may be included in asynchronous write operations 415.

In some examples, apparatus 400 may also include a store component 422-4. Store component 422-4 may be a logic and/or feature executed by circuitry 420 to cause the data included in the plurality of asynchronous write operations to be stored to the one or more storage memory devices. In some first examples, store component 422-4 may utilize a buffer memory to at least temporarily store the data and then cause the data to be committed for storage to the one or more storage memory devices responsive to a completion indication of the disjointed atomic write transaction from the source of the multi-block write transaction request. The commit indication may be included in commit 430 and may include the transaction identification. Store component 422-4 may then send an indication of a successful storage of the data in complete 445. In some second examples, store component 422-4 may not utilize a buffer memory and may cause the data to be directly stored to physical memory addresses of the one or more storage memory devices. For either the first or second examples, the source of the multi-block transaction request may send a cancel indication in cancel 435 to indicate that the disjointed atomic write transaction is to be terminated. Responsive to the cancel indication store component may discard the data or allow the data to be overwritten at the buffer memory or overwritten at the one or more storage memory devices.

According to some examples, apparatus 400 may also include a table component 422-5. Table component 422-5 may be a logic and/or feature executed by circuitry 420 to create a transaction-specific L2P indirection table for mapping the data for the plurality of asynchronous write operations to the physical memory address that stores component 422-4 directly stored to the one or more storage memory devices as mentioned above for the second example. Table component 422-5 may maintain the transaction-specific L2P indirection-table with transaction-specific L2P indirection table 423-b (e.g., in an LUT). In some examples, the source of the multi-block transaction request may send a cancel indication in cancel 435 to indicate that the disjointed atomic write transaction is to be terminated. For these examples, table component 422-5 may discard the transaction-specific L2P indirection table responsive to the cancel indication.

In some examples, apparatus 400 may also include an update component 422-6. Update component 422-6 may be a logic and/or feature executed by circuitry 420 to update a primary L2P indirection table for the one or more storage memory devices based on the transaction-specific L2P indirection table generated by table component 422-5. The update may be responsive to an indication of a completion of the disjointed atomic write transaction received from the source of the multi-block transaction request. The indication may be included in commit 430.

According to some examples, apparatus 400 may also include a power-fail component 422-7. Power-fail component 422-7 may be a logic and/or feature executed by circuitry 420 to cause data stored to the one or more memory storage devices to be preserved or accessible following a detected power-fail event indicated in power-fail 450. In examples where a buffer memory including volatile memory is used to store data for a disjointed atomic write transaction, power-fail component 422-7 may utilize an auxiliary power source (e.g., capacitance-based power) to transfer data from the buffer memory to the one or more storage memory devices. In examples where a transaction-specific L2P indirection table stored to volatile memory is used to update a primary L2P indirection table, power-fail component 422-7 may utilize the auxiliary power source to either enable update component 422-6 to update the primary L2P indirection table before all power is lost or may be utilized to transfer the transaction-specific L2P indirection table and then enable update component 422-6 to update the primary L2P indirection table once power is restored.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

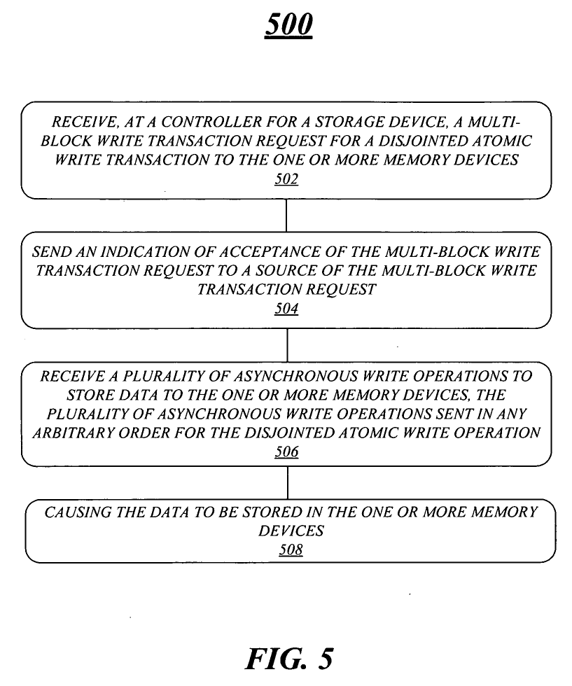

FIG. 5 illustrates an example of a logic flow 500. Logic flow 500 may be representative of some or all of the operations executed by one or more logic, features, or devices described herein, such as apparatus 400. More particularly, logic flow 500 may be implemented by one or more of request component 422-1, token component 422-2, transaction component 422-3 or store component 422-4.

According to some examples, logic flow 500 at block 502 may receive, at a controller for a storage device, a multi-block write transaction request for a disjointed atomic write transaction to the one or more storage memory devices. For these examples, request component 422-1 may receive the multi-block write transaction request for the disjointed atomic write transaction.

In some examples, logic flow 500 at block 504 may send an indication of acceptance of the multi-block write transaction request to a source of the multi-block write transaction request. For these examples, token component 422-2 may generate and send the indication.

According to some examples, logic flow 500 at block 506 may receive a plurality of asynchronous write operations to store data to the one or more storage memory devices, the plurality of asynchronous write operations for the disjointed atomic write operation. For these examples, transaction component 422-3 may receive the plurality of asynchronous write transactions for the disjointed atomic write operation.

In some examples, logic flow 500 at block 508 may cause the data to be stored in the one or more storage memory devices. For these examples, storage component 422-4 may cause the data to be stored in the one or more storage memory devices.

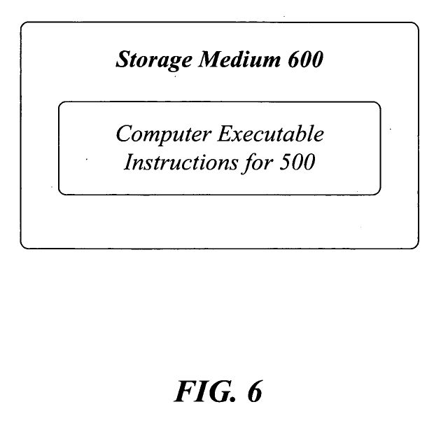

FIG. 6 illustrates an example of a first storage medium. As shown in FIG. 6, the first storage medium includes a storage medium 600. The storage medium 600 may comprise an article of manufacture. In some examples, storage medium 600 may include any non-transitory computer readable medium or machine readable medium, such as an optical, magnetic or semiconductor storage. Storage medium 600 may store various types of computer executable instructions, such as instructions to implement logic flow 500. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

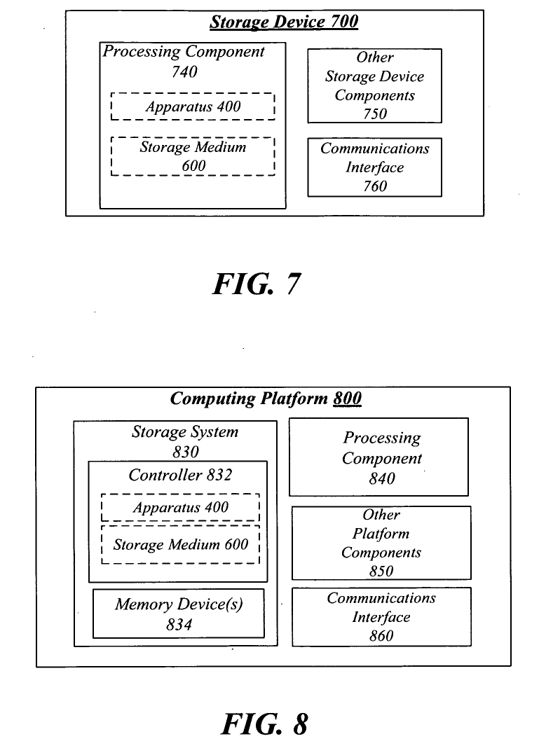

FIG. 7 illustrates an example storage device 700. In some examples, as shown in FIG. 7, storage device 700 may include a processing component 740, other storage device components 750 or a communications interface 760. According to some examples, storage device 700 may be capable of being coupled to a host computing device or platform.

According to some examples, processing component 740 may execute processing operations or logic for apparatus 400 and/or storage medium 600. Processing component 740 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, ASIC, programmable logic devices (PLD), digital signal processors (DSP), FPGA/programmable logic, memory units, logic gates, registers, semiconductor device, chips, microchips, chip sets, and so forth. Examples of software elements may include software components, programs, applications, computer programs, application programs, device drivers, system programs, software development programs, machine programs, operating system software, middleware, firmware, software components, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other storage device components 750 may include common computing elements or circuitry, such as one or more processors, multi-core processors, co-processors, memory units, chipsets, controllers, interfaces, oscillators, timing devices, power supplies, and so forth. Examples of memory units may include without limitation various types of computer readable and/or machine readable storage media in the form of one or more higher speed memory units, such as read-only memory (ROM), RAM, DRAM, DDR DRAM, synchronous DRAM (SDRAM), DDR SDRAM, SRAM, programmable ROM (PROM), EPROM, EEPROM, flash memory, ferroelectric memory, SONOS memory, polymer memory such as ferroelectric polymer memory, nanowire, FeTRAM or FeRAM, ovonic memory, phase change memory, memristers, STT-MRAM, magnetic or optical cards, and any other type of storage media suitable for storing information.

In some examples, communications interface 760 may include logic and/or features to support a communication interface. For these examples, communications interface 760 may include one or more communication interfaces that operate according to various communication protocols or standards to communicate over direct or network communication links. Direct communications may occur via use of communication protocols such as SMBus, PCIe, NVMe, QPI, SATA, SAS or USB communication protocols. Network communications may occur via use of communication protocols Ethernet, Infiniband, SATA or SAS communication protocols.

Storage device 700 may be arranged as an SSD or an HDD that may be configured as described above for storage device 120 of system 100 as shown in FIG. 1. Accordingly, functions and/or specific configurations of storage device 700 described herein, may be included or omitted in various embodiments of storage device 700, as suitably desired.

The components and features of storage device 700 may be implemented using any combination of discrete circuitry, ASICs, logic gates and/or single chip architectures. Further, the features of storage device 700 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the example storage device 700 shown in the block diagram of FIG. 7 may represent one functionally descriptive example of many potential implementations. Accordingly, division, omission or inclusion of block functions depicted in the accompanying figures does not infer that the hardware components, circuits, software and/or elements for implementing these functions would necessarily be divided, omitted, or included in embodiments.

FIG. 8 illustrates an example computing platform 800. In some examples, as shown in FIG. 8, computing platform 800 may include a storage system 830, a processing component 840, other platform components 850 or a communications interface 860. According to some examples, computing platform 800 may be implemented in a computing device.

According to some examples, storage system 830 may be similar to storage device 120 of system 100 as shown in FIG. 1 and includes a controller 832 and memory devices(s) 834. For these examples, logic and/or features resident at or located at controller 832 may execute at least some processing operations or logic for apparatus 400 and may include storage media that includes storage medium 600. Also, memory device(s) 834 may include similar types of volatile or non-volatile memory (not shown) that are described above for storage device 120 shown in FIGS. 1-3.

According to some examples, processing component 840 may include various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, ASIC, PLD, DSP, FPGA/programmable logic, memory units, logic gates, registers, semiconductor device, chips, microchips, chip sets, and so forth. Examples of software elements may include software components, programs, applications; computer programs, application programs, system programs, software development programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

In some examples, other platform components 850 may include common computing elements, such as one or more processors, multi-core processors, co-processors, memory units, chipsets, controllers, peripherals, interfaces, oscillators, timing devices, video cards, audio cards, multimedia I/O components (e.g., digital displays), power supplies, and so forth. Examples of memory units associated with either other platform components 850 or storage system 830 may include without limitation, various types of computer readable and machine readable storage media in the form of one or more higher speed memory units, such as ROM, RAM, DRAM, DDRAM, SDRAM, SRAM, PROM, EPROM, EEPROM, flash memory, ferroelectric memory, SONOS memory, polymer memory such as ferroelectric polymer memory, nanowire, FeTRAM or FeRAM, ovonic memory, nanowire, EEPROM, phase change memory, memristers, STT-MRAM, magnetic or optical cards, an array of devices such as RAID drives, solid state memory devices, SSDs, HDDs or any other type of storage media suitable for storing information.

In some examples, communications interface 860 may include logic and/or features to support a communication interface. For these examples, communications interface 860 may include one or more communication interfaces that operate according to various communication protocols or standards to communicate over direct or network communication links. Direct communications may occur through a direct interface via use of communication protocols or standards described in one or more industry standards (including progenies and variants) such as those associated with the SMBus specification, the PCIe specification, the NVMe specification, the SATA specification, SAS specification or the USB specification. Network communications may occur through a network interface via use of communication protocols or standards such as those described in one or more Ethernet standards promulgated by the IEEE. For example, one such Ethernet standard may include IEEE 802.3-2012, Carrier sense Multiple access with Collision Detection (CSMA/CD) Access Method and Physical Layer Specifications, Published in December 2012 (hereinafter “IEEE 802.3”).

Computing platform 800 may be part of a computing device that may be, for example, user equipment, a computer, a personal computer (PC), a desktop computer, a laptop computer, a notebook computer, a netbook computer, a tablet, a smart phone, embedded electronics, a gaming console, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of computing platform 800 described herein, may be included or omitted in various embodiments of computing platform 800, as suitably desired.

The components and features of computing platform 800 may be implemented using any combination of discrete circuitry, ASICs, logic gates and/or single chip architectures. Further, the features of computing platform 800 may be implemented using microcontrollers, programmable logic arrays and/or microprocessors or any combination of the foregoing where suitably appropriate. It is noted that hardware, firmware and/or software elements may be collectively or individually referred to herein as “logic”, “circuit” or “circuitry.”

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations may be stored on a tangible, machine readable medium and supplied to various customers or manufacturing facilities to load into the fabrication machines that actually make the logic or processor.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may include an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

The follow examples pertain to additional examples of technologies disclosed herein.

### Example 1

An example apparatus may include one or more memory devices and a storage controller that includes logic, at least a portion of which is in hardware. The logic of the apparatus may receive a multi-block write transaction request for a disjointed atomic write transaction to the one or more memory devices. The logic may also send an indication of acceptance of the multi-block write transaction request to a source of the multi-block write transaction request. The logic may also receive a plurality of asynchronous write operations sent in any arbitrary order to store data to the one or more memory devices, the plurality of asynchronous write operations for the disjointed atomic write transaction. The logic may also cause the data to be stored in the one or more memory devices.

### Example 2

The apparatus of example 1, may include the apparatus coupled with a host computing device. For this example, the source of the multi-block write transaction request may be an application or operating system executing at the host computing device.

### Example 3

The apparatus of example 1 may also include a buffer memory. The logic for the apparatus may also cause the data to be stored in the one or more memory devices includes the logic to at least temporarily cause the data to be stored in the buffer memory.

### Example 4

The apparatus of example 3, the indication of acceptance of the multi-block write transaction request includes a transaction identification for the multi-block write transition request. The plurality of received asynchronous write operations may separately include the transaction identification.

### Example 5

The apparatus of example 4, the logic may also cause the data to be committed for storage in the one or more memory devices based on an indication of a completion of the disjointed atomic write transaction. The indication of the completion of the disjointed atomic write transaction may include a commit indication from the source of the multi-block write transaction request that includes the transaction identification.

### Example 6

The apparatus of example 3, the logic may also receive an indication to end or cancel the disjointed atomic write transaction before completion of the disjointed atomic operation. The logic may also cause the data at least temporarily stored in the buffer memory to be deleted or cause the data to not be stored in the one or more memory devices.

### Example 7

The apparatus of example 4, the buffer memory may include non-volatile or volatile types of memory and the one or more memory devices may include non-volatile types of memory.

### Example 8

The apparatus of example 5, the buffer memory may include the volatile type of memory. For this example the logic may receive an indication of a completion of the disjointed atomic write transaction that includes a commit indication from the source of the multi-block write transaction request. The logic may also detect a power-fail event that removes primary power to the buffer memory before at least a portion of the data has been stored in the one or more storage devices. The logic may also utilize auxiliary power to cause the at least a portion of data to be stored from the volatile type of memory to the one or more memory devices.

### Example 9

The apparatus of example 7, auxiliary power may include capacitance-based auxiliary power and primary power comprises a battery-based or power outlet-based power.

### Example 10

The apparatus of example 1 may also include a table memory. The logic to cause the data to be stored in the one or more memory devices may include the logic to cause the data for the plurality of asynchronous write operations to be stored in physical memory addresses of the one or more memory devices. For this example, the logic may also create an L2P indirection table for mapping the plurality of asynchronous write operations to the physical memory addresses. The logic may also store the transaction-specific L2P indirection table in a table memory. The logic may also update a primary L2P indirection table for the one or more memory devices based on the transaction-specific L2P indirection table responsive to whether an indication of a completion of the disjointed atomic write transaction or an indication to end the disjointed atomic write transaction has been received.

### Example 11

The apparatus of example 10, the logic may also receive the indication of the completion of the disjointed atomic write transaction. The indication of the completion of the disjointed atomic write transaction may include a commit indication from the source of the multi-block write transaction request. The logic may also update the primary L2P indirection table based on the transaction-specific L2P indirection table responsive to the commit indication.

### Example 12

The apparatus of example 10, the logic may also receive the indication to end the disjointed atomic write transaction, the indication to end the disjointed atomic write transaction includes a cancel indication from the source of the multi-block write transaction request. The logic may also discard the transaction-specific L2P indirection table or cause the primary L2P indirection table to not be updated with the transaction-specific L2P indirection table responsive to the cancel indication.

### Example 13

The apparatus of example 10, the table memory may include a non-volatile type of memory or a volatile type of memory.

### Example 14

The apparatus of example 13, the table memory include the volatile type of memory, the logic may receive an indication of a completion of the disjointed atomic write transaction that includes a commit indication from the source of the multi-block write transaction request. The logic may also detect a power-fail event that removes primary power to the table memory before the primary L2P indirection table has been updated based on the transaction-specific L2P indirection table. The logic may also utilize auxiliary power to cause the primary L2P indirection table to be updated based on the transaction-specific L2P indirection table.

### Example 15

The apparatus of example 14, auxiliary power may include capacitance-based auxiliary power.

### Example 16

The apparatus of example 13, the table memory includes the non-volatile type of memory. The logic may receive an indication of a completion of the disjointed atomic write transaction that includes a commit indication from the source of the multi-block write transaction request. The logic may also detect a power-fail event that removes primary power to the table memory before the primary L2P indirection table has been updated based on the transaction-specific L2P indirection table. The logic may also update the primary L2P indirection table based on the transaction-specific L2P indirection table responsive to primary power being restored to the table memory.

### Example 17

The apparatus of example 1, the one or more memory devices may include one or more types of non-volatile memory to include 3-dimensional cross-point memory, flash memory, ferroelectric memory, SONOS memory, polymer memory, ferroelectric polymer memory, FeTRAM, FeRAM, ovonic memory, nanowire, electrically EEPROM, phase change memory, memristors or STT-MRAM.

### Example 18

An example method may include receiving, at a controller for a storage device, a multi-block write transaction request for a disjointed atomic write transaction to the one or more memory devices. The method may also include sending an indication of acceptance of the multi-block write transaction request to a source of the multi-block write transaction request. The method may also include receiving a plurality of asynchronous write operations sent in any arbitrary order to store data to the one or more memory devices, the plurality of asynchronous write operations for the disjointed atomic write operation. The method may also include causing the data to be stored in the one or more memory devices.

### Example 19

The method of example 18, comprising the storage device coupled with a host computing device. For this example, the source of the multi-block write transaction request may be an application or an operating system executing at the host computing device.

### Example 20

The method of example 18, causing the data to be stored in the one or more memory devices may include at least temporarily storing the data in a buffer memory maintained at the storage device.

### Example 21

The method of example 20 may include causing the data to be committed for storage in the one or more memory devices based on an indication of a completion of the disjointed atomic write transaction. For this example, the indication of the completion of the disjointed atomic write transaction may include a commit indication from the source of the multi-block write transaction request.

### Example 22

The method of example 20 may include receiving an indication to end or cancel the disjointed atomic write transaction before completion of the disjointed atomic operation. The method may also include discarding the data at least temporarily stored in the buffer memory or causing the data to not be stored in the one or more memory devices.

### Example 23

The method of example 20, the buffer memory may include non-volatile or volatile types of memory and the one or more memory devices include non-volatile types of memory

### Example 24

The method of example 23, the buffer memory includes the volatile type of memory. The method may also include receiving an indication of a completion of the disjointed atomic write transaction that includes a commit indication from the source of the multi-block write transaction request. The method may also include detecting a power-fail event for the storage device before at least a portion of the data has been stored in the one or more storage devices. The method may also include using auxiliary power to cause the at least a portion of data to be stored from the volatile type of memory to the one or more memory devices.

### Example 25

The method of example 23, auxiliary power may include capacitance-based auxiliary power.

### Example 26

The method of example 18, causing the data to be stored in the one or more memory devices may include causing the data for the plurality of asynchronous write operations to be stored in physical memory addresses of the one or more memory devices. Causing the data to be stored in the one or more storage devices may also include creating an L2P indirection table for mapping the data for the plurality of asynchronous write operations to the physical memory addresses. Causing the data to be stored in the one or more storage devices may also include maintaining the transaction-specific L2P indirection table in a table memory maintained at the storage device. Causing the data to be stored in the one or more storage devices may also include updating a primary L2P indirection table for the one or more memory devices based on the transaction-specific L2P indirection table responsive to whether an indication of a completion of the disjointed atomic write transaction or an indication to end the disjointed atomic write transaction has been received.

### Example 27

The method of example 26 may also include receiving the indication of the completion of the disjointed atomic write transaction. The indication of the completion of the disjointed atomic write transaction may include a commit indication from the source of the multi-block write transaction request. The method may also include updating the primary L2P indirection table based on the transaction-specific L2P indirection table responsive to the commit indication.

### Example 28

The method of example 26 may also include receiving the indication to end the disjointed atomic write transaction. The indication to end the disjointed atomic write transaction may include a cancel indication from the source of the multi-block write transaction request. The method may also include discarding the transaction-specific L2P indirection table or cause the primary L2P indirection table to not be updated with the transaction-specific L2P indirection table responsive to the cancel indication.

### Example 29

The method of example 26, the table memory may include a non-volatile type of memory or a volatile type of memory.

### Example 30

The method of example 29, the table memory including the volatile type of memory. The method may also include receiving an indication of a completion of the disjointed atomic write transaction that includes a commit indication from the source of the multi-block write transaction request. The method may also include detecting a power-fail event for the storage device before the primary L2P indirection table has been updated based on the transaction-specific L2P indirection table. The method may also include using auxiliary power to cause the primary L2P indirection table to be updated based on the transaction-specific L2P indirection table.

### Example 31

The method of example 30, auxiliary power may include capacitance-based auxiliary power.

### Example 32

The method of example 29, the table memory may include the non-volatile type of memory. The method may also include receiving an indication of a completion of the disjointed atomic write transaction that includes a commit indication from the source of the multi-block write transaction request. The method may also include detecting a power-fail event for the storage device before the primary L2P indirection table has been updated based on the transaction-specific L2P indirection table. The method may also include updating the primary L2P indirection table based on the transaction-specific L2P indirection table responsive to power being restored in the storage device.

### Example 33

The method of example 18, the one or more memory devices may include one or more types of non-volatile memory to include 3-dimensional cross-point memory, flash memory, ferroelectric memory, SONOS memory, polymer memory, ferroelectric polymer memory, FeTRAM, FeRAM, ovonic memory, nanowire, electrically EEPROM, phase change memory, memristors or STT-MRAM.

### Example 34

An example at least one machine readable medium may include a plurality of instructions that in response to being executed by system at a storage device may cause the system to carry out a method according to any one of examples 18 to 33.

### Example 35

An apparatus may include means for performing the methods of any one of examples 18 to 33.

### Example 36

An example system may include a processor for a host computing device to execute one or more applications. The system may also include a storage device coupled with the computing platform, the storage device including one or more memory devices and a storage controller that includes logic, at least a portion of which is in hardware, the logic to receive a multi-block write transaction request from an application executed by the processor. The multi-block write transaction request may be for a disjointed atomic write transaction to the one or more memory devices. The logic may also send an indication of acceptance of the multi-block write transaction request to the application. The logic may also receive a plurality of asynchronous write operations from the application to store data to the one or more memory devices. The logic may also cause the data to be stored in the one or more memory devices.

### Example 37

The system of example 36, the storage device may include a buffer memory. For this example, the logic may cause the data to be stored in the one or more memory devices includes the logic to at least temporarily cause the data to be stored in the buffer memory.

### Example 38

The system of example 37, the logic may also cause the data to be committed for storage in the one or more memory devices based on an indication of a completion of the disjointed atomic write transaction. For this example, the indication of the completion of the disjointed atomic write transaction may include a commit indication from the application.

### Example 39

The system of example 38, the logic may also receive an indication from the application to end or cancel the disjointed atomic write transaction before completion of the disjointed atomic operation. The logic may also cause the data at least temporarily stored in the buffer memory to be deleted or cause the data to not be stored in the one or more memory devices.

### Example 40

The system of example 38, the buffer memory may include non-volatile or volatile types of memory and the one or more memory devices may include non-volatile types of memory

### Example 41

The system of example 40, the buffer memory includes the volatile type of memory. For this example, the logic may receive an indication of a completion of the disjointed atomic write transaction that includes a commit indication from the application. The logic may also detect a power-fail event for the storage device before at least a portion of the data has been stored in the one or more storage devices. The logic may also utilize auxiliary power to cause the at least a portion of data to be stored from the volatile type of memory to the one or more memory devices.

### Example 42

The system of example 40, auxiliary power may include capacitance-based auxiliary power.

### Example 43

The system of example 36, the storage device may include a table memory. For this example, the logic to cause the data to be stored in the one or more memory devices may include the logic to cause the data for the plurality of asynchronous write operations to be stored in physical memory addresses of the one or more memory devices. The logic may also create an L2P indirection table for mapping the data for the plurality of asynchronous write operations to the physical memory addresses. The logic may also store the transaction-specific L2P indirection table in the table memory. The logic may also update a primary L2P indirection table for the one or more memory devices based on the transaction-specific L2P indirection table responsive to whether an indication of a completion of the disjointed atomic write transaction or an indication to end the disjointed atomic write transaction has been received.

### Example 44

The system of example 43, the logic may also receive the indication of the completion of the disjointed atomic write transaction. For this example, the indication of the completion of the disjointed atomic write transaction from the application that includes a commit indication. The logic may also update the primary L2P indirection table based on the transaction-specific L2P indirection table responsive to the commit indication.

### Example 45

The system of example 43, the logic may also receive the indication to end the disjointed atomic write transaction. For this example, the indication to end the disjointed atomic write transaction may include a cancel indication from the application. The logic may also discard the transaction-specific L2P indirection table or cause the primary L2P indirection table to not be updated with the transaction-specific L2P indirection table responsive to the cancel indication.

### Example 46

The system of example 43, the table memory may include a non-volatile type of memory or a volatile type of memory.

### Example 47

The system of example 46, the table memory includes the volatile type of memory. For this examples, the logic may receive an indication of a completion of the disjointed atomic write transaction that includes a commit indication from the application. The logic may also detect a power-fail event for the storage device before the primary L2P indirection table has been updated based on the transaction-specific L2P indirection table. The logic may also utilize auxiliary power to cause the primary L2P indirection table to be updated based on the transaction-specific L2P indirection table.

### Example 48

The system of example 47, auxiliary power may include capacitance-based auxiliary power.

### Example 49

The system of example 46, the table memory includes the non-volatile type of memory. For this example, the logic may receive an indication of a completion of the disjointed atomic write transaction that includes a commit indication from the application. The logic may also detect a power-fail event for the storage device before the primary L2P indirection table has been updated based on the transaction-specific L2P indirection table. The logic may also update the primary L2P indirection table based on the transaction-specific L2P indirection table responsive to power being restored in the storage device.

### Example 50

The system of example 36, the one or more memory devices may include one or more types of non-volatile memory to include 3-dimensional cross-point memory, flash memory, ferroelectric memory, SONOS memory, polymer memory, ferroelectric polymer memory, FeTRAM, FeRAM, ovonic memory, nanowire, electrically EEPROM, phase change memory, memristors or STT-MRAM.

### Example 51

The system of example 36 may also include a digital display coupled with the processor to present a user interface view.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
one or more memory devices; and
a storage controller that includes logic, at least a portion of which is in hardware, the logic to:
receive a multi-block write transaction request for a disjointed atomic write transaction to the one or more memory devices;
send an indication of acceptance of the multi-block write transaction request to a source of the multi-block write transaction request;
receive a plurality of asynchronous write operations to store data to the one or more memory devices, the plurality of asynchronous write operations sent in any arbitrary order for the disjointed atomic write operation; and
cause the data to be stored in the one or more memory devices.

2. The apparatus of claim 1, comprising the apparatus coupled with a host computing device, the source of the multi-block write transaction request is an application or operating system executing at the host computing device.

3. The apparatus of claim 1, comprising:
a buffer memory; and
the logic to cause the data to be stored in the one or more memory devices includes the logic to at least temporarily cause the data to be stored in the buffer memory.

4. The apparatus of claim 3, comprising:
the indication of acceptance of the multi-block write transaction request includes a transaction identification for the multi-block write transition request; and
the plurality of received asynchronous write operations separately including the transaction identification.

5. The apparatus of claim 4, comprising the logic to:
cause the data to be committed for storage in the one or more memory devices based on an indication of a completion of the disjointed atomic write transaction, the indication of the completion of the disjointed atomic write transaction includes a commit indication from the source of the multi-block write transaction request that includes the transaction identification.

6. The apparatus of claim 4, comprising the logic to:
receive an indication to end or cancel the disjointed atomic write transaction before completion of the disjointed atomic operation; and
cause the data at least temporarily stored in the buffer memory to be deleted or cause the data to not be stored in the one or more memory devices.

7. The apparatus of claim 4, the buffer memory includes non-volatile or volatile types of memory and the one or more memory devices include non-volatile types of memory.

8. The apparatus of claim 7, comprising the buffer memory including the volatile type of memory, the logic to:
receive an indication of a completion of the disjointed atomic write transaction that includes a commit indication from the source of the multi-block write transaction request;
detect a power-fail event that removes primary power to the buffer memory before at least a portion of the data has been stored in the one or more storage devices; and
utilize auxiliary power to cause the at least a portion of data to be stored from the volatile type of memory to the one or more memory devices.

9. The apparatus of claim 7, auxiliary power comprises capacitance-based auxiliary power and primary power comprises a battery-based or power outlet-based power.

10. The apparatus of claim 1, the one or more memory devices comprises one or more types of non-volatile memory to include 3-dimensional cross-point memory, flash memory, ferroelectric memory, silicon-oxide-nitride-oxide-silicon (SONOS) memory, polymer memory, ferroelectric polymer memory, ferroelectric transistor random access memory (FeTRAM or FeRAM), ovonic memory, nanowire, electrically erasable programmable read-only memory (EEPROM), phase change memory, memristors or spin transfer torque-magnetoresistive random access memory (STT-MRAM).

11. A method comprising:
receiving, at a controller for a storage device, a multi-block write transaction request for a disjointed atomic write transaction to the one or more memory devices;
sending an indication of acceptance of the multi-block write transaction request to a source of the multi-block write transaction request;
receiving a plurality of asynchronous write operations to store data to the one or more memory devices, the plurality of asynchronous write operations sent in any arbitrary order for the disjointed atomic write operation; and
causing the data to be stored in the one or more memory devices.

12. The method of claim 11, causing the data to be stored in the one or more memory devices comprises:
causing the data for the plurality of asynchronous write operations to be stored in physical memory addresses of the one or more memory devices;
creating a transaction-specific logical-to-physical (L2P) indirection table for mapping the data for the plurality of asynchronous write operations to the physical memory addresses;
maintaining the transaction-specific L2P indirection table in a table memory maintained at the storage device; and
updating a primary L2P indirection table for the one or more memory devices based on the transaction-specific L2P indirection table responsive to whether an indication of a completion of the disjointed atomic write transaction or an indication to end the disjointed atomic write transaction has been received.

13. The method of claim 12, comprising:
receiving the indication of the completion of the disjointed atomic write transaction, the indication of the completion of the disjointed atomic write transaction includes a commit indication from the source of the multi-block write transaction request; and
updating the primary L2P indirection table based on the transaction-specific L2P indirection table responsive to the commit indication.

14. The method of claim 12, comprising:
receiving the indication to end the disjointed atomic write transaction, the indication to end the disjointed atomic write transaction includes a cancel indication from the source of the multi-block write transaction request; and
discarding the transaction-specific L2P indirection table or cause the primary L2P indirection table to not be updated with the transaction-specific L2P indirection table responsive to the cancel indication.

15. A system comprising:
a processor for a host computing device to execute one or more applications; and
a storage device coupled with the host computing platform, the storage device including:
one or more memory devices; and
a storage controller that includes logic, at least a portion of which is in hardware, the logic to:
receive a multi-block write transaction request from an application executed by the processor, the multi-block write transaction request for a disjointed atomic write transaction to the one or more memory devices;
send an indication of acceptance of the multi-block write transaction request to the application;
receive a plurality of asynchronous write operations from the application to store data to the one or more memory devices; and
cause the data to be stored in the one or more memory devices.

16. The system of claim 15, comprising:
the storage device including a buffer memory; and
the logic to cause the data to be stored in the one or more memory devices includes the logic to at least temporarily cause the data to be stored in the buffer memory.

17. The system of claim 15, comprising the logic to:
cause the data to be committed for storage in the one or more memory devices based on an indication of a completion of the disjointed atomic write transaction, the indication of the completion of the disjointed atomic write transaction includes a commit indication from the application.

18. The system of claim 15, comprising:
the storage device including a table memory;
the logic to cause the data to be stored in the one or more memory devices includes the logic to:
cause the data for the plurality of asynchronous write operations to be stored in physical memory addresses of the one or more memory devices;
create a transaction-specific logical-to-physical (L2P) indirection table for mapping the data for the plurality of asynchronous write operations to the physical memory addresses;
store the transaction-specific L2P indirection table in the table memory; and
update a primary L2P indirection table for the one or more memory devices based on the transaction-specific L2P indirection table responsive to whether an indication of a completion of the disjointed atomic write transaction or an indication to end the disjointed atomic write transaction has been received.

19. The system of claim 18, comprising the logic to:
receive the indication of the completion of the disjointed atomic write transaction, the indication of the completion of the disjointed atomic write transaction from the application that includes a commit indication; and
update the primary L2P indirection table based on the transaction-specific L2P indirection table responsive to the commit indication.

20. The system of claim 18, comprising the logic to:
receive the indication to end the disjointed atomic write transaction, the indication to end the disjointed atomic write transaction includes a cancel indication from the application; and
discard the transaction-specific L2P indirection table or cause the primary L2P indirection table to not be updated with the transaction-specific L2P indirection table responsive to the cancel indication.

21. The system of claim 18, the table memory includes a non-volatile type of memory or a volatile type of memory.

22. The system of claim 21, the table memory comprising the volatile type of memory, the logic to:
receive an indication of a completion of the disjointed atomic write transaction that includes a commit indication from the application;
detect a power-fail event for the storage device before the primary L2P indirection table has been updated based on the transaction-specific L2P indirection table; and
utilize auxiliary power to cause the primary L2P indirection table to be updated based on the transaction-specific L2P indirection table.

23. The system of claim 22, auxiliary power comprises capacitance-based auxiliary power.

24. The system of claim 21, the table memory comprising the non-volatile type of memory, the logic to:
receive an indication of a completion of the disjointed atomic write transaction that includes a commit indication from the application;
detect a power-fail event for the storage device before the primary L2P indirection table has been updated based on the transaction-specific L2P indirection table; and
update the primary L2P indirection table based on the transaction-specific L2P indirection table responsive to power being restored in the storage device.

25. The system of claim 15, the one or more memory devices comprises one or more types of non-volatile memory to include 3-dimensional cross-point memory, flash memory, ferroelectric memory, silicon-oxide-nitride-oxide-silicon (SONOS) memory, polymer memory, ferroelectric polymer memory, ferroelectric transistor random access memory (FeTRAM or FeRAM), ovonic memory, nanowire, electrically erasable programmable read-only memory (EEPROM), phase change memory, memristors or spin transfer torque-magnetoresistive random access memory (STT-MRAM).
